(19) United States
(12) Patent Application Publication
(10) Pub. No.: US 2019/0295065 A1
(43) Pub. Date: Sep. 26, 2019

(54) AFFILIATED STORE LABELING METHOD, AFFILIATED STORE LABELING DEVICE, AND AFFILIATED STORE LABELING SYSTEM FOR WIRELESS LAN FINGERPRINT

(71) Applicant: VISOFT CORP., LTD., Daejeon (KR)

(72) Inventor: Dongsoo HAN, Daejeon (KR)

(73) Assignee: VISOFT CORP., LTD., Daejeon (KR)

(21) Appl. No.: 16/316,655

(22) PCT Filed: Jul. 14, 2016
(86) PCT No.: PCT/KR2016/007676

§ 371 Date: Jan. 10, 2019

(51) Int. Cl. G06Q 20/32; G06Q 20/40

(52) U.S. Cl. CPC G06Q 20/3278; H04W 84/12; G06Q 20/409; G06Q 20/3223

(57) ABSTRACT

The present invention relates to a labeling method for a wireless LAN fingerprint, which is performed in a computer server and, more particularly, to an affiliated store labeling method for a wireless LAN fingerprint, the method of labeling the wireless LAN fingerprint as an affiliated store identifier to generate a fingerprint-affiliated store association database. In the affiliated store labeling method for the wireless LAN fingerprint, the method includes: receiving, at a first step, payment transaction information that is generated as card payment is performed via a card payment terminal at an affiliated store and fingerprint collection information that the a mobile terminal generates by detecting a nearby wireless LAN signal; and assigning, at a second step, the affiliated store identifier included in the payment transaction information to the wireless LAN fingerprint included in the fingerprint collection information by using common information that is included in both the payment transaction information and the fingerprint collection information as a link.

### TECHNICAL FIELD

The present invention relates to an affiliated store labeling method, an affiliated store labeling device, and an affiliated store labeling system for labeling a wireless LAN fingerprint as an identifier of an affiliated store. Further, the present invention relates to an affiliated store labeling method, an affiliated store labeling device, and an affiliated store labeling system for a wireless LAN fingerprint, in which the wireless LAN fingerprint is labeled as an identifier of an affiliated store using information obtained during a process of performing card payment by a mobile terminal via a payment terminal of an affiliated store.

### BACKGROUND ART

Various services are implemented using mobile terminals such as smartphones. For example, a smartphone has a payment app therein and the payment app performs payment for goods or services provided in credit card affiliated stores by utilizing pre-registered payment means.

The smartphone has a module capable of transmitting magnetic field signals, NFC signals, or the like. When a user puts the smartphone close to a payment terminal of the affiliated store, the payment app performs payment by controlling the module to transmit credit card information or single-use credit card information stored in a memory.

The payment terminal of the affiliated store is able to recognize the credit card information or the single-use credit card information embedded in the smartphone via the magnetic field signals or the NFC signals, and is able to use the credit card information so as to request payment approval for the goods or services provided in the affiliated store. As described above, in order for the payment app, which uses the magnetic field signals, the NFC signals, or the like, to perform payment processing, the smartphone having the payment app is put close to the payment terminal of the affiliated store.

In the meantime, smartphone location recognition technology using wireless signals from an access point (AP) in a wireless local area network (WLAN) is known. For example, the smartphone recognizes the wireless signal from one or more APs at the current location and generates a wireless LAN fingerprint that includes an identifier of the recognized AP and the signal strength of the wireless signal in at least one pair. The generated wireless LAN fingerprint is transmitted to a location server, and the location server compares the received wireless LAN fingerprint to a fingerprint on a radio map which is already established. According to the result of the comparison, the location of the smartphone is estimated or specified.

The radio map is a database that includes wireless LAN fingerprints and location information corresponding (mapped) to the wireless LAN fingerprints in pairs as an array. The location information is data indicating the locations where the wireless LAN fingerprints are collected, and expressed as, for example, coordinate information on the map.

Various techniques for establishing the radio map are known. For example, a technique of labeling the wireless LAN fingerprint by manually assigning location information to the wireless LAN fingerprint is known. This manual technique is able to specify accurate collection locations, but has a problem that it is expensive to establish a radio map targeting a wide range.

Further, in a semi-autonomous learning technique, it is known that a wireless LAN fingerprint of which the collection location is not known is labeled using the wireless LAN fingerprint of which the collection location is known as a reference location. Furthermore, other autonomous learning techniques are known.

Radio map establishment targeting a wide range is practically impossible with the manual technique, but is achieved using the autonomous or semi-autonomous learning techniques. Required is a method of establishing a radio map using the autonomous or semi-autonomous learning techniques from a number of wireless LAN fingerprints of which the collection locations are not known.

As described above, when a smartphone user makes a card payment using the payment app, the smartphone is put close to the payment terminal of a particular affiliated store where the payment takes place. Using this point, the wireless LAN fingerprint collected at the time of payment or before and after the payment may be estimated to be collected at the location of the corresponding affiliated store.

### DISCLOSURE

### Technical Problem

Accordingly, the present invention has been made keeping in mind the above problems occurring in the prior art, and an object of the present invention is to provide a new labeling method, a new labeling device, and a new labeling system for labeling a wireless LAN fingerprint.

Also, an object of the present invention is to provide a labeling method, a labeling device, and a labeling system for semi-automatically or automatically labeling a wireless LAN fingerprint.

It is to be understood that technical problems to be solved by the present invention are not limited to the aforementioned technical problems and other technical problems which are not mentioned will be apparent from the following description to a person with an ordinary skill in the art to which the present invention pertains.

### Technical Solution

According to one aspect of the present invention, there is provided an affiliated store labeling method for a wireless LAN fingerprint performed in a computer server, wherein the wireless LAN fingerprint is labeled as an affiliated store identifier to generate a fingerprint-affiliated store association database.

In the affiliated store labeling method for the wireless LAN fingerprint, the method may further include: receiving, at a first step, payment transaction information that is generated as card payment is performed via a card payment terminal at an affiliated store and fingerprint collection information that the a mobile terminal generates by detecting a nearby wireless LAN signal; and assigning, at a second step, the affiliated store identifier included in the payment transaction information to the wireless LAN fingerprint included in the fingerprint collection information by using common information that is included in both the payment transaction information and the fingerprint collection information as a link.

In the affiliated store labeling method for the wireless LAN fingerprint, the method may further include: receiving, at a first step, association information that includes both the affiliated store identifier obtained in a process of performing card payment by a mobile terminal via an affiliated store terminal and the wireless LAN fingerprint collected by the mobile terminal in an associated manner; and generating, at a second step, the fingerprint-affiliated store association database using the received association information.

In the affiliated store labeling method for the wireless LAN fingerprint, the method may further include: receiving, from a mobile terminal, recognition information that includes the wireless LAN fingerprint collected by the mobile terminal using recognition of a Bluetooth tag or beacon installed at an affiliated store and an identifier of the Bluetooth tag or beacon or the affiliated store identifier; and generating the fingerprint-affiliated store association database using the recognition information.

According to another aspect of the present invention, there is provided an affiliated store labeling device for a wireless LAN fingerprint, wherein the wireless LAN fingerprint is labeled as an affiliated store identifier to generate a fingerprint-affiliated store association database.

In the affiliated store labeling device for the wireless LAN fingerprint, the device may further include: a communication unit receiving payment transaction information that is generated as card payment is performed via a card payment terminal at an affiliated store and fingerprint collection information that a mobile terminal generates by detecting a nearby wireless LAN signal; and a control unit assigning the affiliated store identifier included in the payment transaction information to the wireless LAN fingerprint included in the fingerprint collection information by using common information that is included in both the payment transaction information and the fingerprint collection information as a link.

In the affiliated store labeling device for the wireless LAN fingerprint, the device may further include: a communication unit receiving association information that includes both the affiliated store identifier obtained in a process of performing card payment by a mobile terminal via an affiliated store terminal and the wireless LAN fingerprint collected by the mobile terminal in an associated manner; and a control unit generating the fingerprint-affiliated store association database using the received association information.

In the affiliated store labeling device for the wireless LAN fingerprint, the device may further include: a communication unit receiving, from a mobile terminal, recognition information that includes the wireless LAN fingerprint collected by the mobile terminal using recognition of a Bluetooth tag or beacon installed at an affiliated store and an identifier of the Bluetooth tag or beacon or the affiliated store identifier; and a control unit generating the fingerprint-affiliated store association database using the recognition information.

According to still another aspect of the present invention, there is provided a recording medium storing an app installed on a mobile terminal, wherein the app is configured to perform at least: generating, at a first step, association information that includes both an affiliated store identifier obtained in a process of performing card payment by the mobile terminal via an affiliated store terminal and a wireless LAN fingerprint collected by the mobile terminal in an associated manner; and transmitting, at a second step, the association information to a computer server, and the association information is used to generate a fingerprint-affiliated store association database in which the computer server labels the wireless LAN fingerprint as the affiliated store identifier. The app may be a payment app installed on the mobile terminal to perform the card payment.

### Advantageous Effects

In the affiliated store labeling method, the affiliated store labeling device, and the affiliated store labeling system for wireless LAN fingerprint according to the present invention, a new type of database, a fingerprint-affiliated store association database, is provided and the new database is useful for identifying an affiliated store directly from a wireless LAN fingerprint and is used directly in various application services related to the card affiliated store.

Also, in the affiliated store labeling method, the affiliated store labeling device, and the affiliated store labeling system for wireless LAN fingerprint according to the present invention, the fingerprint-affiliated store association database is easily established and updated in association with a card payment process.

Also, in the affiliated store labeling method, the affiliated store labeling device, and the affiliated store labeling system for wireless LAN fingerprint, the generated fingerprint-affiliated store association database is used to generate a wireless LAN radio map and helps in easily generating the wireless LAN radio map.

Effects that may be obtained from the present invention will not be limited to only the above described effects. In addition, other effects which are not described herein will become apparent to those skilled in the art from the following description.

### DESCRIPTION OF DRAWINGS

FIG. 1 is a view showing an example system diagram of an affiliated store labeling system for a wireless LAN fingerprint.

FIG. 2 is a view showing an example configuration of fingerprint collection information and payment transaction information.

FIG. 3 is a view showing an example configuration of a mobile terminal.

FIG. 4 is a view showing an example configuration of an affiliated store labeling device.

FIG. 5 is a view showing an example control flow for labeling a wireless LAN fingerprint for an affiliated store identifier.

FIG. 6 is a view showing an example process of clustering.

FIG. 7 is a view showing an example of labeling that assigns a location between affiliated stores in a wireless LAN fingerprint sequence.

### BEST MODE

The above-described objects, features, and advantages will be more clearly understood from the following detailed description with reference to the accompanying drawings. Accordingly, the technical scope of the present invention can be easily embodied by those skilled in the art to which the present invention belongs. Also, in describing the present invention, it is decided that if a detailed description of the known art related to the present invention makes the subject matter of the present invention unclear, the detailed description will be omitted. Hereinafter, preferred embodiments of the present invention will be described with reference to the accompanying drawings.

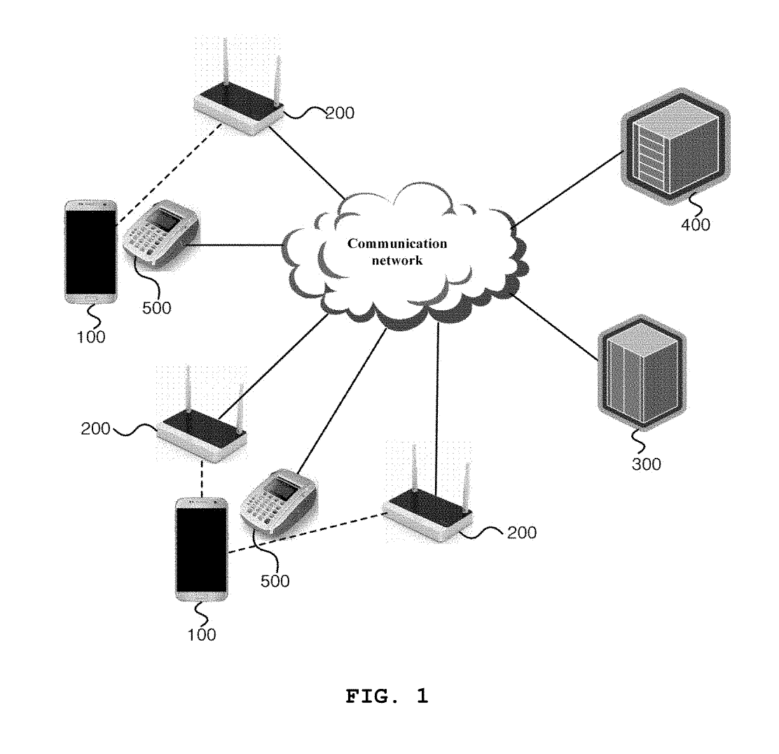

FIG. 1 is a view showing an example system diagram of an affiliated store labeling system for a wireless LAN fingerprint.

According to FIG. 1, an affiliated store labeling system for a wireless LAN fingerprint includes at least one mobile terminal 100, at least one wireless AP 200, a payment server 300, a card payment terminal 500, and an affiliated store labeling device 400.

Describing components of FIG. 1, the mobile terminal 100 is a terminal for collecting wireless LAN fingerprints. The mobile terminal 100 belongs to a general user, and may access a wireless communication network or Internet while moving. The mobile terminal 100 may be, for example, a mobile phone, a smartphone, a table PC, a notebook, etc.

In order to purchase an object in an off-line affiliated store, the user may active a function of a credit card or debit card integrated in his or her mobile terminal 100, and perform card payment, that is, payment transaction, through the card payment terminal 500 of the affiliated store.

The mobile terminal 100 performs functions required by the user through various integrated application programs (hereinafter, briefly, referred as “app” or “app program”). In addition, at least one app is configured to perform a function of a wireless LAN fingerprint and to collect the same.

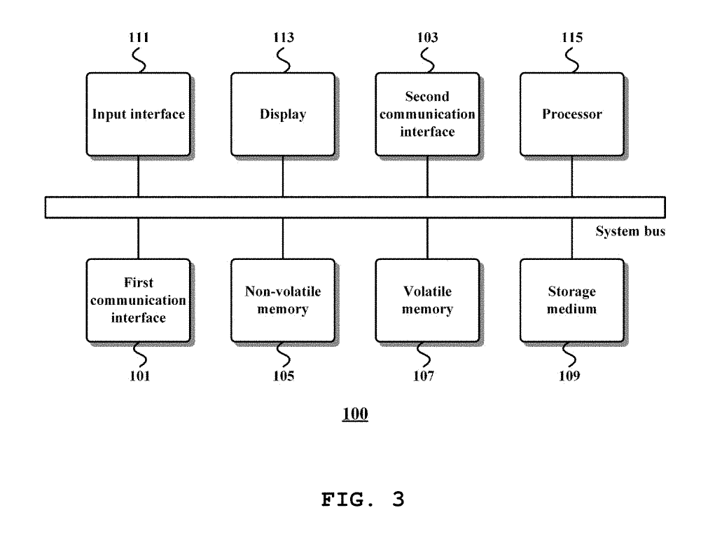

The mobile terminal 100 configures fingerprint collection information including collected wireless LAN fingerprint, and transmits to the affiliated store labeling device 400 the generated fingerprint collection information through a communication network. The mobile terminal 100 will be described in detail with reference to FIG. 3. The fingerprint collection information may be information generated by detecting the nearby wireless LAN signal by the mobile terminal 100.

The wireless access point (AP) 200 is a device constituting a wireless LAN network, and the mobile terminal 100 may perform communication with another device within the wireless LAN through the wireless AP 200, or another device, apparatus, or computer server through the Internet.

The wireless AP 200 may periodically transmit a beacon signal such that an arbitrary or authorized mobile terminal 100 access thereto. A beacon signal includes, for example, an identifier of the wireless AP 200 such as a service set identifier (SSID) or a basic service set identifier (BSSID), and the mobile terminal 100 may extract the same from a beacon signal.

The payment server 300 is a server for processing payment through a card, and the payment server 300 receives payment request information including card information (for example, number of credit card), affiliated store identifier (for example, serial number assigned to an affiliated store), an approval request (payment request) amount, etc. from the card payment terminal 500 by being connected to at least one card payment terminal 500.

By receiving payment request information, the payment server 300 determines whether or not to approve the card request through performing authentication and verification according to the card information, and transmits the result of determining whether or not to approve to the card payment terminal that has been transmitted the request.

The payment server 300 configures various types of data as each of payment transaction information according to a payment request and approval, and stores the same in a database (for example, a payment record database). Payment transaction information is information generated by performing card payment through the card payment terminal 500 of the affiliated store, and each entry representing payment transaction information includes data of a payment transaction identifier, an affiliated store identifier, a payer identifier, a card number, a card expiration date, a payment amount, a payment time, and the like.

As described above, the payment server 300 determines whether or not to approve according to a payment request, generates one entry in a payment record database, and store various types of information related to credit card payment.

The affiliated store labeling device 400 may be implemented by a computer server, and performs labeling for a wireless LAN fingerprint as an affiliated store identifier. The affiliated store labeling device 400 collects wireless LAN fingerprints through, for example, various mobile terminals 100, and determines a wireless LAN fingerprint related to card payment among collected wireless LAN fingerprints. The affiliated store labeling device 400 performs labeling for the determined wireless LAN fingerprint or a wireless LAN fingerprint configured on the basis of the above as an identifier of the affiliated store for which the card payment is performed.

For collecting information related to the card payment, and automatically associating with an affiliated store for which the card payment is performed and with a wireless LAN fingerprint collected in the corresponding affiliated store, a fingerprint-affiliated store association database is generated by performing labeling for a wireless LAN fingerprint as an affiliated store identifier. Herein, “generating” means a concept of establishing and updating such a database.

The affiliated store labeling device 400 will be described in detail later which reference to FIG. 3.

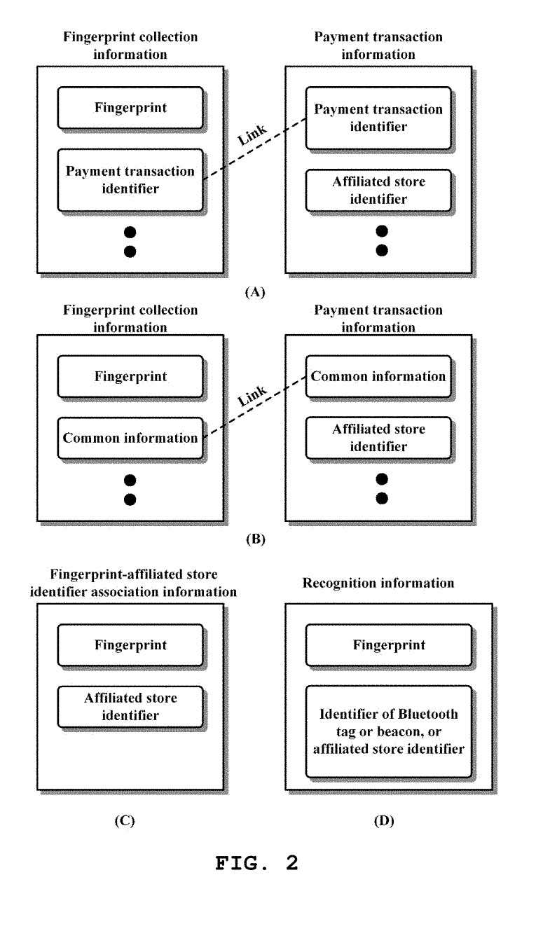

FIG. 2 is a view showing an example configuration of the fingerprint collection information and payment transaction information. FIGS. 2(A) and 2(B) are example views of configuring the fingerprint collection information and payment transaction information.

The fingerprint collection information is generated by detecting an adjacent wireless LAN signal by the mobile terminal 100, and the mobile terminal 100 transmits the same to the affiliated store labeling device 400.

The fingerprint collection information includes a wireless LAN fingerprint collected where the mobile terminal 100 is located, and a wireless LAN fingerprint may include a pair piece of information where an identifier of the wireless AP 200 and signal strength of a signal received from the corresponding wireless AP 200 are included as much as the number of wireless APs 200. The mobile terminal 100 configures a wireless AP identifier and signal strength in a pair by recognizing a wireless LAN signal from the wireless AP 200 at a specific time or during an assigned time period by using an executing app, and configures a wireless LAN fingerprint including at least one pair of pieces of information. The fingerprint collection information may further include a “payment transaction identifier” (FIG. 2(A)) or “common information” (FIG. 2(B)). The fingerprint collection information may be generated by payment app installed in the mobile terminal 100 for performing the card payment (FIG. 2(A)), or by another app differing from the payment app (FIG. 2(B)).

Payment transaction identifier is a identifier possibly specifying the card payment that is to be performed, that is, a payment transaction, and may be an identifier assigned by the payment server 300 or card payment terminal 500, or may be a combination of a plurality of pieces of information so as to identify a corresponding payment transaction in association with the card payment. For example, the payment transaction identifier may be a combination of a part of the entire of a payer name (user name), a payment time (recognition time), a payment affiliated store, credit card information (number of credit card and expiration date), etc. The payment transaction identifier is used when associating the fingerprint collection information and payment transaction information later.

At a time at which the credit card payment (payment transaction) is performed, the mobile terminal 100 collects a wireless LAN fingerprint, and configures the fingerprint collection information. Configuration may be performed by including a payment transaction identifier possibly specifying the corresponding card payment, and the same may be transmitted to the affiliated store labeling device 400. In the mobile terminal 100, an app for the card payment may generate the fingerprint collection information and transmit to the affiliated store labeling device 400.

Payment transaction information is information generated by performing the card payment through the card payment terminal of the affiliated store, the card payment terminal 500 or payment server 300 or both may generate payment transaction information of the corresponding card payment and transmit the same to the affiliated store labeling device 400. Alternatively, the payment app of the mobile terminal 100 may generate payment transaction information, and transmit the same. Payment transaction information may include at least a payment transaction identifier and an affiliated store identifier.

Common information is information commonly included in payment transaction information and the fingerprint collection information, and is used when associating a payment transaction and a fingerprint. The mobile terminal 100 may collect a wireless LAN fingerprint while the card payment is recognized, but may also collect a wireless LAN fingerprint while the card payment is not recognized. In latter case, labeling may be performed for a wireless LAN fingerprint by associating the fingerprint collection information and payment transaction information by using common information.

Common information is information commonly included in the fingerprint collection information and payment transaction information, and includes visual information and a user identifier or an identifier of the mobile terminal 100. For example, when an identifier of the mobile terminal 100 in which the fingerprint collection information and payment transaction information are included is identical, and a generation time thereof of is identical, it may be estimated that a wireless LAN fingerprint included in the corresponding fingerprint collection information is collected at a time at which the card payment of the corresponding payment transaction information is performed.

A payment transaction identifier or common information is used later as a link when performing, by the affiliated store labeling device 400, affiliated store labeling by assigning an affiliated store identifier included in payment transaction information to a wireless LAN fingerprint included in the fingerprint collection information from payment transaction information and the fingerprint collection information. A payment transaction identifier may be identified in a form of common information.

FIG. 3 is a view showing an example block diagram of the mobile terminal 100.

According to FIG. 3, the mobile terminal 100 includes a first communication interface 101 for accessing a wireless LAN (or mobile communication network or both); a storage medium 109 of at least one of a volatile memory 107, a non-volatile memory 105, and a hard disk storing various types of apps and information, and for executing the same; an input interface 111 for receiving a user input; a display 113 outputting a result according to an input or executing a program; a processor 115 operating apps; and a second communication interface 103 for transmitting and receiving a magnetic signal or NFC (near field communication) signal or Bluetooth signal. The first communication interface 101 may access a recognized wireless LAN network or may be connected thereto, or further, may access a mobile communication network.

Describing a function of the mobile terminal 100 related to the present invention with reference to a block diagram of FIG. 3, the mobile terminal 100 may access a wireless LAN or through the first communication interface 101 or may be connected to the Internet by accessing a mobile communication network. The second communication interface 103 may transmit to or receive from a wireless signal another device within an adjacent distance (for example, a card payment terminal, a Bluetooth tag, or beacon).

The non-volatile memory 105 of the mobile terminal 100 may store various types of data and information. For example, the non-volatile memory 105 may store at least one piece of credit card information which is preregistered in the mobile terminal 100. Credit card information includes, for example, a credit card number, an expiration date of the credit card, a name of the credit card company, etc., and may generate single-use credit card information according to a design.

The mobile terminal 100 may store various app programs in the non-volatile memory 105 and the storage medium 109, and execute the corresponding app program through the processor 115 according to a selection through the input interface 111 or automatically.

For example, the mobile terminal 100 stores, in the non-volatile memory 105 or the storage medium 109, the payment app for performing the credit card payment in conjunction with the card payment terminal, a service app for providing a service related to a particular affiliated store, and a general app that the user uses regardless of payment or the affiliated store. The processor 115 loads the app for execution.

The payment app, which is an app for performing the card payment in conjunction with the card payment terminal, operates in the processor 115 according to the user's selection, and accesses credit card information stored in the non-volatile memory 105, or the like or generates single-use credit card information in conjunction with the server for the payment app. The selected credit card information is output to the card payment terminal via the second communication interface 103 according to the user's selection.

The service app may provide service related to one particular affiliated store or an affiliated store in a chain. The service app is a menu order app for browsing a menu in the corresponding affiliated store and making an order, an alarm reception app for informing that the ordered item on the menu according to the order is ready to be provided, or a discount coupon app for offering a discount coupon available at the affiliated store. This service app, which is an app available at the corresponding affiliated store that provides the service, is recognized via the Bluetooth tag or beacon, is connected to the corresponding affiliated store by the user, or operates by other known paging methods.

The general app is an app that the user of the mobile terminal 100 generally utilizes regardless of the card payment or of the service of the affiliated store. The general app may be a phone call app that performs a phone call function, a text message app that transmits and receives text messages, a SNS app that connects to a social network, a web browser that connects to the Internet, and the like.

As described above, the mobile terminal 100 stores the payment app, the service app, and/or the general app in the non-volatile memory 105 or in the storage medium 109 according to the installed apps. The apps are loaded into the processor 115 according to the user's selection or automatically for execution.

The arbitrary mobile terminal 100 is configured in such a manner that at least one among the payment app, the service app, and/or the general app collects the wireless LAN fingerprints and generates the fingerprint collection information to transmit the fingerprint collection information to the affiliated store labeling device 400 over the communication network.

The type of arbitrary app for collecting the wireless LAN fingerprints may be determined in advance or dynamically depending on the connection to the affiliated store labeling device 400.

The method of collecting the wireless LAN fingerprint may be different from each app type, and each app is loaded into the processor 115 to collect and transmit the wireless LAN fingerprints.

The payment app is executed by the user of the mobile terminal 100 and transmits the card information selected by the user to the card payment terminal 500 adjacent thereto via the second communication interface 103. The second communication interface 103 is a communication interface for one-on-one communication with the card payment terminal, and is capable of performing communication only when being close to the card payment terminal at the affiliated store.

The card payment terminal 500 generates payment request information that includes the received card information, the input payment amount (approval request amount), and the approval request affiliated store identifier, for transmission to the payment server 300. The payment server 300 may transmit response data indicating approval or disapproval to the card payment terminal and to the payment app. The response data contains the approval time, the affiliated store identifier, the approval amount, the card information, the payer (user) name, and the like. As described above, the response data contains data that specifies the card payment.

The payment app collects the wireless LAN fingerprint via the first communication interface 101 while the card payment is performed. Here, the collected wireless LAN fingerprint may be considered as a fingerprint collected from the affiliated store where the card payment takes place. For example, after the payment app transmits the card information via the second communication interface 103, while waiting for the response from the payment server 300, the payment app recognizes a wireless LAN signal from the nearby wireless AP 200, obtains an identifier of the wireless AP 200 from the wireless LAN signal, measures the signal strength with respect to the wireless LAN signal, generates the wireless LAN fingerprint including the identifier of the wireless AP 200 and the signal strength in a pair, and temporarily stores the wireless LAN fingerprint in the volatile memory 107, or the like.

Then, the payment app generates the fingerprint collection information that includes the temporarily stored wireless LAN fingerprint and the payment transaction identifier. The payment app may transmit the fingerprint collection information that is generated at the time of card payment as described above to the affiliated store labeling device 400 over the Internet.

Other types of apps (hereinafter, referred to as “the other app”), such as the service app or the general app rather than the payment app operates automatically by the mobile terminal 100 or by the user input. The other app may operate while being in the affiliated store, such as at the time when the payment is performed at the affiliated store, before or after the payment. The collection of the wireless LAN fingerprints may need to be extensive and may be configured in such a manner as to collect the wireless LAN fingerprints corresponding to the affiliated store utilizing the other app, in which it is difficult to specify the affiliated store, according to the embodiment of the present invention.

The other app is configured to collect the wireless LAN fingerprints in addition to the specified provision function. The other app periodically collects the wireless LAN fingerprints from the wireless AP 200 via the first communication interface 101 according to a specified period. The other app may transmit the fingerprint collection information that includes the fingerprint generated each period and the common information, to the affiliated store labeling device 400. The common information may be explicitly included in the fingerprint collection information, but may be known by the affiliated store labeling device 400 using an implicit method.

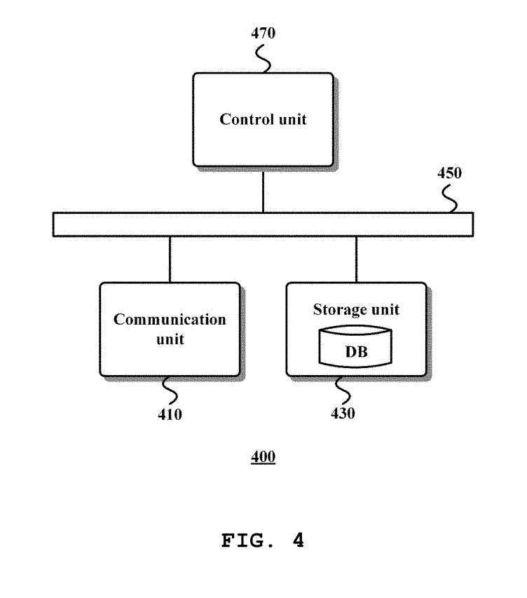

FIG. 4 is a view showing an example configuration of an affiliated store labeling device 400.

Referring to FIG. 4, the affiliated store labeling device 400 includes a communication unit 410, a storage unit 430, a connection unit 450, and a control unit 470. FIG. 4 shows a function block diagram, and each function block has a corresponding hardware block, preferably. The affiliated store labeling device 400 in FIG. 4 may be configured using various types of hardware. For example, the affiliated store labeling device 400 may be a computer server configured using one or more PCs, workstations, and/or main frames. Other blocks not shown in FIG. 3 may be further included in this block diagram according to the design change. The detailed description with reference to FIGS. 1 to 3 will be briefly described below.

The affiliated store labeling device 400 performs a function of labeling the wireless LAN fingerprint as an affiliated store identifier. The affiliated store labeling device 400 receives fingerprint collection information from multiple mobile terminals 100 connected thereto, and assigns a particular affiliated store identifier to the wireless LAN fingerprint so as to generate the fingerprint-affiliated store association database.

The affiliated store labeling device 400 may operate as a server having multiple mobile terminals 100 as clients. Further, the affiliated store labeling device 400 may identify the affiliated store where the mobile terminal 100 is located from the wireless LAN fingerprint which is received from the arbitrary mobile terminal 100 using the fingerprint-affiliated store association database so as to inform the mobile terminal 100 of the affiliated store or to provide various types of information or services available at the affiliated store. This function may be performed by another computer server other than the affiliated store labeling device 400.

Regarding the affiliated store labeling device 400 with reference to FIG. 4, the communication unit 410 is an interface for communication with one or more mobile terminals 100 and/or payment servers 300.

The communication unit 410 receives the fingerprint collection information and the payment transaction information from the arbitrary mobile terminal 100 and the payment server 300 that are able to access the affiliated store labeling device 400 over the communication network. The fingerprint collection information includes the wireless LAN fingerprint collected by the mobile terminal 100 and also includes the payment transaction identifier or common information.

The storage unit 430 stores various types of data and programs. The storage unit 430 includes a mass storage medium, such as a hard disk, and the like, to store various types of data. The storage unit 430 may configure a database using one or more hard disks. The storage unit 430 may be embedded in a separate apparatus or device. For example, the storage unit 430 may store various types of data, programs, and databases within separate equipment, and may provide particular data according to arbitrary data access.

The storage unit 430 configures various types of data in a form of a database, and typically includes a payment record database, a fingerprint database, and the fingerprint-affiliated store association database, and may further include a user database, a map database, and the like.

An arbitrary database may be received from another server or may be stored. For example, the payment record database may be periodically received or accessed from the payment server 300. The arbitrary database may be updated dynamically. According to the present invention, the fingerprint-affiliated store association database may be generated and updated using the payment record database and the fingerprint database.

The payment record database contains at least one piece of payment transaction information as each entry. The payment transaction information includes the payment transaction identifier, the affiliated store identifier, the payer identifier, the card number, the card expiration date, the payment amount, the payment time, and the like. The payment record database is accumulated and updated as the card payment is performed.

The fingerprint database uses and stores at least one piece of fingerprint collection information received from the arbitrary mobile terminal 100 as an entry. Each entry includes the wireless LAN fingerprint and the common information or the payment transaction identifier.

The fingerprint-affiliated store association database consists of one or more entries, and each entry is stored with association between the wireless LAN fingerprint and the affiliated store identifier. The wireless LAN fingerprint associated with the affiliated store is configured using the wireless LAN fingerprints in the fingerprint database, and it is not necessary for the wireless LAN fingerprint to be the same as an arbitrary wireless LAN fingerprint. The wireless LAN fingerprint associated with the affiliated store may be referred to as a representative fingerprint hereinafter in terms of representing the corresponding affiliated store.

The fingerprint-affiliated store association database may be configured using the payment record database and the fingerprint database, and the fingerprint-affiliated store association database may be accumulated and updated by the control unit 470.

Using the payment transaction information and the payment transaction identifier or common information which are included in the fingerprint collection information as a link, the control unit 470 labels the wireless LAN fingerprint as the affiliated store identifier and generates the fingerprint-affiliated store association database through a process of assigning the affiliated store identifier included in the payment transaction information to the wireless LAN fingerprint included in the fingerprint collection information.

The user database contains one or more entries. Each entry contains one or more identifiers related to the user. For example, the entry may contain a user ID, a user (payer) name, a MAC address, an IP address of the mobile terminal 100, a mobile phone number, or the like for identifying the user in the app of the mobile terminal 100. Via the entry, the user may be specified, and whether different types of recognized user identifiers indicate the same user may be determined.

The connection unit 450 transmits and receives data between blocks within the affiliated store labeling device 400. The connection unit 450 is configured using a local area network, a parallel bus, a serial bus, and the like.

The control unit 470, which has one or more execution units, loads a program stored in the storage unit 430 and executes instruction code of the program via the execution units.

The control unit 470 is configured to assign the (representative) wireless LAN fingerprint to the affiliated store, for example, the control unit 470 receives the payment transaction information from the payment server 300, and the like via the communication unit 410, generates the received payment transaction information as each entry for storage in the payment record database of the storage unit 430. Also, the control unit 470 receives the fingerprint collection information from the mobile terminal 100, and the like via the communication unit 410, and configures the received fingerprint collection information as each entry for storage in the fingerprint database of the storage unit 430. A series of pieces of fingerprint collection information received by the user of a particular mobile terminal 100 may be used to configure a wireless LAN fingerprint sequence.

As the control unit 470 accumulates and updates the entry in the payment record database and in the fingerprint database, the wireless LAN fingerprint is labeled as the affiliated store identifier according to a predetermined condition, and the labeled wireless LAN fingerprint and the corresponding affiliated store (affiliated store identifier) are configured as an entry for storage in the fingerprint-affiliated store association database.

For example, when the number of currently accumulated payment record databases and fingerprint databases exceeds a set value or when an accumulation period (for example, 10 days, or the like) is exceeded, the control unit 470 determines, with respect to pieces of the payment transaction information in the payment record database and pieces of the fingerprint collection information in the fingerprint database, the payment transaction and the wireless LAN fingerprint associated with each other using the payment transaction information and the common information or the payment transaction identifier which are included in the fingerprint collection information as a link.

The control unit 470 associates the wireless LAN fingerprint with the affiliated store, and stores the affiliated store identifier and the (representative) wireless LAN fingerprint associated with each other in a pair as an entry in the fingerprint-affiliated store association database or updates the existing entry (the entry having the same affiliated store identifier).

As described above, the control unit 470 may utilize accumulated payment record database and fingerprint database to generate a new entry in the fingerprint-affiliated store association database or to update the existing entry.

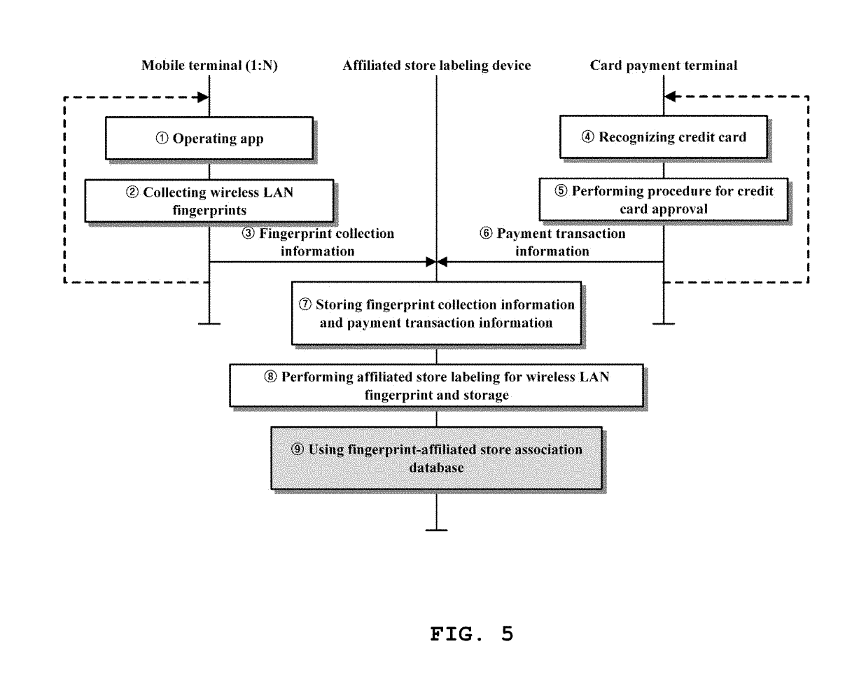

FIG. 5 is an exemplary view showing a process of generating the fingerprint-affiliated store association database by labeling the wireless LAN fingerprint as the affiliated store identifier and a process of using the same.

The control flow for labeling consists of collaboration between multiple apparatuses (devices, and terminals). Control and data transmission/reception performed in each device, and the like are performed via a configuration block of each device.

For example, the processor 115 of the mobile terminal 100 may perform a function of executing the app program to control other blocks, and may transmit or receive the generated data via the first communication interface 101. Further, regarding the affiliated store labeling device 400, the control unit 470 operates the program stored in the storage unit 430 to process various types of data or information received via the communication unit 410 and to update the database of the storage unit 430. The detailed description with reference to FIGS. 1 to 4 will be briefly described herein.

First, the user of the mobile terminal 100 may operate the payment app or other apps at the arbitrary affiliated store via the input interface 111 (referring to \textcircled{1}). The operating app may collect the wireless LAN fingerprints and may generate the fingerprint collection information for transmission to the affiliated store labeling device 400 over the Internet.

The operating app may be the payment app, the service app, or the general app. While performing the payment, while accessing the service at the affiliated store, or at regular intervals, the corresponding app recognizes wireless LAN signals via the first communication interface 101 and collects the wireless LAN fingerprints from the wireless LAN signals (referring to \textcircled{2}).

The operating app generates the fingerprint collection information, which includes the collected wireless LAN fingerprint and the common information or payment transaction identifier, and transmits the generated fingerprint collection information to the affiliated store labeling device 400 (referring to \textcircled{3}).

The control unit 470 of the affiliated store labeling device 400 may receive the fingerprint collection information from the mobile terminal 100 via the communication unit 410. Available arbitrary mobile terminals 100 may repeatedly generate the the fingerprint collection information according to the operation of the app for transmission to the affiliated store labeling device 400.

In the meantime, the card payment terminal 500 recognizes a payment card, for example, a credit card to perform the card payment. The card payment terminal 500 recognizes the payment card, such as a credit card (referring to \textcircled{4}). For example, the card payment terminal 500 may have a credit card reader module to obtain credit card information from the magnetic tape of the credit card or from the mobile terminal 100. The card payment terminal may obtain the credit card information, such as a credit card number, and the like from the credit card itself, or may obtain the credit card information via the second communication interface 103 of the mobile terminal 100.

The card payment terminal 500 performs a procedure for payment approval of the credit card according to the input payment amount by using the recognized credit card information (referring to \textcircled{5}). For example, the card payment terminal may construct the payment request information, which includes the recognized credit card information, the affiliated store identifier, the approval (payment) request amount, and the like, may transmit the payment request information to the payment server 300, and may receive a response for approval or disapproval.

Further, the affiliated store labeling device 400 may receive the payment transaction information according to the credit card payment (approval) via the card payment terminal 500, the payment server 300, or the like (referring to \textcircled{6}).

As described above, the card payment terminal may repeatedly process the processing related to the credit card payment, and may process the cost of goods or service provided to an arbitrary user by a credit card.

The affiliated store labeling device 400 receives one or more pieces of the fingerprint collection information from the mobile terminal 100 according to a generation event of the wireless LAN fingerprint, and receives the payment transaction information from the payment server 300 or card payment terminal according to a card payment event. The received fingerprint collection information and the payment transaction information include the payment transaction identifier that specifies the card payment or the common information common to both.

The control unit 470 of the affiliated store labeling device 400 generates the fingerprint collection information received via the communication unit 410 as an entry in the fingerprint database for storage in the storage unit 430, and generates the payment transaction information received via the communication unit 410 as an entry in the payment record database for storage in the storage unit 430 (referring to \textcircled{7}).

Then, when satisfying a set condition (for example, the number of entries, and the elapse of a set period), the control unit 470 of the affiliated store labeling device 400 labels the wireless LAN fingerprint as the affiliated store identifier by using the stored fingerprint collection information and the stored payment transaction information and stores the labeled new or updated entry in the fingerprint-affiliated store association database (referring to \textcircled{8}).

Through the labeling process, the wireless LAN fingerprint for the arbitrary affiliated store may be automatically obtained. The control unit 470 of the affiliated store labeling device 400 searches the database of the storage unit 430, which stores multiple pieces of fingerprint collection information and multiple pieces of payment transaction information, for the fingerprint collection information and the payment transaction information in at least one pair which include the common information or payment transaction identifier common thereto. Through the search, at the very least, the wireless LAN fingerprint generated at the time of particular card payment may be extracted.

The user makes the card payment at the affiliated store, and thus one or preferably multiple wireless LAN fingerprints are found with respect to the affiliated store that is specified (recognized) in the payment transaction information.

With respect to the found fingerprint collection information (or multiple pieces thereof) and the payment transaction information in a pair, the control unit 470 of the affiliated store labeling device 400 performs filtering for each affiliated store, generates a representative fingerprint from the wireless LAN fingerprints in the multiple pieces of the fingerprint collection information filtered for each affiliated store, and assigns the generated representative fingerprint as the wireless LAN fingerprint of the corresponding affiliated store, thereby performing affiliated store labeling of the wireless LAN fingerprint.

For example, regarding the fingerprint collection information and the payment transaction information which are paired with each other, the control unit 470 filters the fingerprint collection information, which has an affiliated store identifier the same as the affiliated store identifier included in the payment transaction information, and the payment transaction information, and extracts a common (intersection) wireless AP identifier among the identifiers of the wireless AP 200 of the filtered wireless LAN fingerprints. The common wireless AP identifier is an identifier of the wireless AP 200, which is included in all of the filtered wireless LAN fingerprints or included in a specified ratio or more.

The control unit 470 calculates an average signal strength corresponding to the common wireless AP identifier. The control unit 470 may calculate the average signal strength by averaging the corresponding signal strengths of the wireless LAN fingerprint that has the common wireless AP identifier.

The control unit 470 may generate the representative fingerprint that includes the common wireless AP identifier and the average signal strength corresponding to the common wireless AP identifier in pairs as many as the number of common wireless APs 200, and may map the representative fingerprint to the affiliated store identifier for configuration as an entry so as to store the new entry in or to update the fingerprint-affiliated store association database of the storage unit 430. As described above, the representative fingerprint corresponding to each affiliated store may be generated and stored in the fingerprint-affiliated store association database.

The fingerprint collection information may be received from the payment app of the mobile terminal 100 over the communication network for storage. The wireless LAN fingerprints stored via the payment app include one or more wireless LAN fingerprints collected via the payment app of the mobile terminal 100 when performing the card payment via the payment app, and further include the payment transaction identifier.

The wireless LAN fingerprints collected via the payment app may be regarded as the wireless LAN fingerprint, recognized at the payment affiliated store, of the payment transaction identifier and may be labeled through the generation of the representative fingerprint as described above.

Further, it is possible that the wireless LAN fingerprint collected via the other app is labeled as the affiliated store identifier. The other app operates and periodically collects the wireless LAN fingerprint according to a set period, and transmits the fingerprint collection information, which includes both the common information common to the information included in the payment transaction information and the collected wireless LAN fingerprint, to the affiliated store labeling device 400 over the communication network. The affiliated store labeling device 400 stores the fingerprint collection information in the fingerprint database.

Assuming that the wireless LAN fingerprint is collected exactly at the time of payment (payment time), the wireless LAN fingerprint is regarded as a wireless LAN fingerprint collected from the affiliated store where the payment is made.

However, there are many cases where the time of collecting the wireless LAN fingerprint does not exactly coincide with the time of card payment. Therefore, the labeling method that is applicable even to this case is proposed.

Considering the usage pattern of the affiliated store, it is very likely that the user will stay at the affiliated store for a predetermined time (for example, 30 minutes) before payment or for a predetermined time after payment. Further, it is considered that similarity between the wireless LAN fingerprints collected by multiple mobile terminals 100 at the same affiliated store is high.

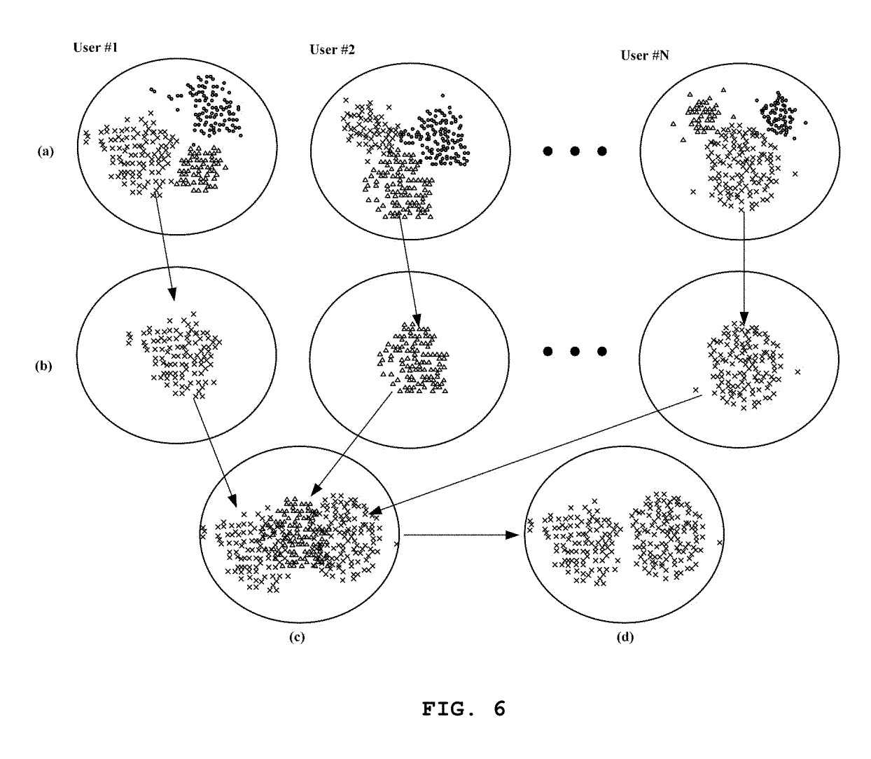

The affiliated store labeling process for the wireless LAN fingerprint collected using the other app will be described with reference to FIG. 6.

Among the wireless LAN fingerprints of the fingerprint collection information, the control unit 470 performs a process of filtering the wireless LAN fingerprints for a specified time before and after the time of card payment and of clustering with mutual similarity between the filtered fingerprints.

More specifically, first, the control unit 470 searches the payment transaction database of the storage unit 430 for the payment transaction information in which the payment has been made to a particular affiliated store.

The wireless LAN fingerprint is filtered using the common information from the found payment transaction information. For example, the payer identifier and the payment time are extracted from the found payment transaction information. The wireless LAN fingerprints that have the user (able to use the user database) the same as the payer and are collected within a predetermined time (for example, 30 minutes) before and after the payment time are filtered in the fingerprint database for each user (N:N is two or more).

The filtered wireless LAN fingerprints for each user are wireless LAN fingerprints collected before and after the time (payment time) when the corresponding user makes the card payment at the very least.

The control unit 470 performs clustering on the wireless LAN fingerprints filtered for each user according to the mutual similarity therebetween (referring to FIG. 5(a)). The mutual similarity may be obtained by measuring the vector distance of the wireless LAN fingerprint. For example, using the Euclidean distance, when being smaller than a set threshold value, it is considered to be similar. In consequence of calculating the mutual similarity, the wireless LAN fingerprints for each user constitute one or more clusters. Each fingerprint cluster may be reduced into the representative fingerprint consisting of the common wireless AP identifier and the average signal strength.

Further, the control unit 470 filters a cluster in the largest size among clusters for each user (referring to FIG. 5(b)) and further performs clustering on the entire wireless LAN fingerprints of the cluster filtered for each user according to mutual similarity (referring to FIG. 5(c)). The representative wireless LAN fingerprint of the largest cluster among the clustered wireless LAN fingerprints is determined as the wireless LAN fingerprint collected at the affiliated store (referring to FIG. 5(d)).

Clustering may utilize a variety of known techniques. For example, the control unit 470 may utilize hierarchical tree clustering or K-means clustering technique, and preferably uses a hierarchical tree clustering technique.

The control unit 470 may generate the entry that includes the affiliated store identifier and the representative wireless LAN fingerprint or may update the existing entry for storage in the fingerprint-affiliated store association database of the storage unit 430.

The fingerprint-affiliated store association database generated as described above may be used in the affiliated store labeling device 400 or other computer servers (referring to □ in FIG. 5).

The fingerprint-affiliated store association database may be used when estimating the affiliated store where the mobile terminal 100 is present. For example, when it is desired to recommend the optimum credit card among multiple credit cards to the mobile terminal 100 located at a particular affiliated store, it is necessary to determine the affiliated store (namely, the affiliated store identifier) where the mobile terminal 100 is present. Here, the fingerprint-affiliated store association database may be used to directly estimate the affiliated store.

Further, the fingerprint-affiliated store association database may be used to configure a wireless LAN radio map. The wireless LAN radio map is a database in the wireless LAN fingerprint and the location information are associated with each other, and is used when estimating the location of the mobile terminal from the wireless LAN fingerprint.

If location information (for example, coordinate information, and the like in the map) of each affiliated store is present, a correspondence relation between the wireless LAN fingerprint and the location information with respect to the point where the affiliated store is present is directly determined from the fingerprint-affiliated store association database. Further, at the point between the affiliated store and the affiliated store, for example, a corridor, a stairway, and the like, the correspondence relation between the wireless LAN fingerprint and the location information is determined by the following method and integration thereof is performed to generate the wireless LAN radio map.

In a series of wireless LAN fingerprints, the control unit 470 configures, as a wireless LAN fingerprint sequence, wireless LAN fingerprints between two wireless LAN fingerprints that have similarity, equal to or larger than a threshold value, to the stored wireless LAN fingerprint corresponding to the affiliated store. Further, the control unit 470 assigns the wireless LAN fingerprints to the path between two or more affiliated stores recognized using the configured wireless LAN fingerprint sequence.

More specifically, the control unit 470 of the affiliated store labeling device 400 extracts a series of wireless LAN fingerprints collected by a single mobile terminal 100 (the user thereof) from pieces of the fingerprint collection information in the fingerprint database. The extracted wireless LAN fingerprints are wireless LAN fingerprints sequentially collected according to the recognition time.

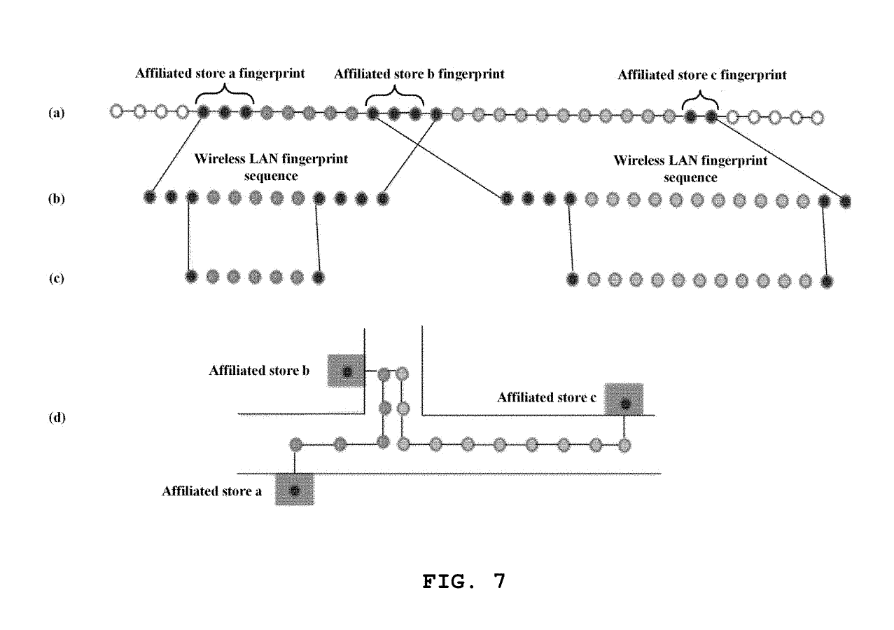

The control unit 470 compares a series of wireless LAN fingerprints with the wireless LAN fingerprint (the representative wireless LAN fingerprint) corresponding to each affiliated store in the fingerprint-affiliated store association database in terms of similarity. The similarity comparison may be calculated as the vector distance between fingerprints, for example, as the Euclidean distance. When the extracted wireless LAN fingerprint has the similarity, equal to or larger than a specified threshold value, to the wireless LAN fingerprint of a particular affiliated store, the control unit 470 marks, among the extracted wireless LAN fingerprints, the wireless LAN fingerprint similar to the particular affiliated store as corresponding to the particular affiliated store (referring to (a) in FIG. 7).

The control unit 470 configures wireless LAN fingerprints included between wireless LAN fingerprints marked as corresponding to two affiliated stores, as a single wireless LAN fingerprint sequence (referring to (b) in FIG. 7).

The wireless LAN fingerprint sequence configured as described above includes wireless LAN fingerprints corresponding to arbitrary locations between at least two affiliated stores. Among the extracted wireless LAN fingerprints, even the wireless LAN fingerprints corresponding to three or more affiliated stores are recognized, cutting between two affiliated stores takes place and multiple wireless LAN fingerprint sequences are configured.

After this, deleting the wireless LAN fingerprints indicating the same affiliated stores at the opposite ends of each of the wireless LAN fingerprint sequences that are separately configured, a reduced wireless LAN fingerprint sequence is configured by the control unit 470 (referring to (c) in FIG. 7).

The control unit 470 places the reduced wireless LAN fingerprint sequence between two affiliated stores by utilizing the map database, and assigns the wireless LAN fingerprints of the reduced wireless LAN fingerprint sequence to the path corresponding to the location between the two affiliated stores (referring to (d) in FIG. 7), thereby determining the location at which the wireless LAN fingerprint is collected.

There are various methods to place the fingerprint sequence of which the opposite ends are the wireless LAN fingerprints collected at the affiliated store or the reduced wireless LAN fingerprint sequence on the path between the two affiliated stores. The simplest method is to place a fingerprint sequence on the minimum path between the two affiliated stores on the basis of the collection time of the collected wireless LAN fingerprints at the opposite ends. However, in this case, if including movements, such as the user temporarily stays in the middle of moving between two affiliated stores or goes back, it is difficult to obtain a good placement result.

As another method, a learning technique may be used whereby reference location information of some wireless LAN fingerprints of which collection location information is known is utilized to place an accumulated fingerprint sequence in the corresponding space. In this technique, referred to as a semi-autonomous learning technique (semi-supervised learning), the accuracy of the reference location has a great influence to the placement performance. The reference location typically uses wireless LAN fingerprints collected by a person checking the collection location or uses the location information, such as GPS signals obtained with the wireless LAN fingerprint. Location information of the stairs and elevator in the building and signal information obtained from an inertial sensor may be utilized to generate the reference location. This may be used because the moment of using the stairs and the moment of using the elevator may be detected from sensing information obtained by a sensor, such as a three-axis accelerometer and a barometer. In terms of the reference location of the semi-autonomous learning technique, a fingerprint sequence generation technique and a wireless LAN fingerprint-affiliated store identifier association database proposed in the present invention may be utilized as a new reference location providing method of the semi-autonomous learning technique.

Further, the target space between affiliated stores may be divided in specified size and a state machine is configured so as to determine the collection location on the map between the affiliated stores. The divided space corresponds to each state of the state machine, and the wireless LAN fingerprint may be regarded as a value observed in each state.

The control unit 470 may label each wireless LAN fingerprint of the fingerprint sequence by associating it with a particular location between affiliated stores, and may generate the entry including the wireless LAN fingerprint and the corresponding location on the map (plan) so as to generate the wireless LAN radio map.

In the above embodiment, it is described that the affiliated store labeling device 400 receives the fingerprint collection information including the wireless LAN fingerprint and the payment transaction information including the affiliated store identifier, and then associates the wireless LAN fingerprint with the affiliated store identifier. However, the mobile terminal 100 may directly generate information in which the wireless LAN fingerprint is associated with the affiliated store identifier.

As shown in FIG. 2(C), the payment app executed on the mobile terminal 100 obtains the affiliated store identifier from the payment terminal 500 directly or from the payment server 300 in the process of performing card payment. Also, in the process of card payment, the wireless LAN fingerprints may be collected from the nearby wireless AP 200 and may be associated with the affiliated store identifier to generate fingerprint-affiliated store identifier association information. The fingerprint-affiliated store association information may be generated by the payment app for performing card payment, which is installed on the mobile terminal 100.

The mobile terminal 100 generates association information that includes the affiliated store identifier obtained via the affiliated store terminal 500 in the process of performing card payment and the wireless LAN fingerprint collected by the mobile terminal 100 in an associated manner, for transmission to the affiliated store labeling device 400. The communication unit 410 of the affiliated store labeling device 400 receives the same.

Further, the control unit 470 of the affiliated store labeling device 400 simply generates the fingerprint-affiliated store association database as accumulating the received association information for updating.

Furthermore, in the above-described embodiments, the fingerprint-affiliated store association database is generated using the card payment process via the card payment terminal 500, but the fingerprint-affiliated store association database may be generated using recognition of the Bluetooth tag or beacon.

The mobile terminal 100 may recognize the Bluetooth tag or beacon installed at the affiliated store and may collect the wireless LAN fingerprints in conjunction therewith. Also, the mobile terminal may transmit, to the affiliated store labeling device 400, recognition information that includes an identifier of the Bluetooth tag or beacon or the corresponding affiliated store identifier and the wireless LAN fingerprint as being associated with each other.

Some known apps perform, when the mobile terminal 100 recognizes the Bluetooth tag or beacon and identifies the affiliated store, payment at the identified affiliated store or make an order from the menu. An app recognizes the Bluetooth tag or beacon, and then collects the wireless LAN fingerprints. The app may obtain the identifier of the Bluetooth tag or beacon, and may obtain the affiliated store identifier through the process of performing payment or making an order from the menu.

Further, the communication unit 410 of the affiliated store labeling device 400 receives the recognition information, and the control unit 470 may generate the fingerprint-affiliated store association database using the recognition information.

When receiving the identifier of the Bluetooth tag or beacon, the affiliated store identifier is obtained from the identifier of the Bluetooth tag or beacon with reference to the database in which the identifier of the Bluetooth tag or beacon is associated with the affiliated store identifier. By assigning the obtained affiliated store identifier to the wireless LAN fingerprint, the fingerprint-affiliated store association database may be established or updated.

The app program mentioned in the above embodiments may be installed on the mobile terminal, and before being installed on the mobile terminal, the app program may be stored in a recording medium of an app store or in a recording medium, such as a USB memory, a flash drive, a hard disk, or the like.

Various substitutions, modifications, and changes from the spirit of the present invention defined in the following claims by those skilled in the art are also included in the scope of the present invention, so that the present invention described above is not limited to the embodiments and the accompanying drawings.

1. An affiliated store labeling method for a wireless LAN fingerprint performed in a computer server, wherein the wireless LAN fingerprint is labeled as an affiliated store identifier to generate a fingerprint-affiliated store association database.

2. The method of claim 1, further comprising:
receiving, at a first step, payment transaction information that is generated as card payment is performed via a card payment terminal at an affiliated store and fingerprint collection information that a mobile terminal generates by detecting a nearby wireless LAN signal; and
assigning, at a second step, the affiliated store identifier included in the payment transaction information to the wireless LAN fingerprint included in the fingerprint collection information by using common information that is included in both the payment transaction information and the fingerprint collection information as a link.

3. The method of claim 2, wherein the common information includes a payment transaction identifier that specifies the card payment to be performed.

4. The method of claim 2, wherein the common information includes visual information and a user identifier or an identifier of the mobile terminal.

5. The method of claim 1, further comprising:
receiving, at a first step, association information that includes both the affiliated store identifier obtained in a process of performing card payment by a mobile terminal via an affiliated store terminal and the wireless LAN fingerprint collected by the mobile terminal in an associated manner; and
generating, at a second step, the fingerprint-affiliated store association database using the received association information.

6. The method of claim 5, wherein the association information is generated by a payment app that is installed on the mobile terminal to perform the card payment.

7. The method of claim 2, wherein the fingerprint collection information includes an identifier of a wireless AP collected by the mobile terminal and signal strength measured for a wireless signal from the wireless AP in at least one pair.

8. The method of claim 2, wherein the fingerprint collection information is generated by an app other than a payment app that is installed on the mobile terminal to perform the card payment.

9. The method of claim 8, wherein the app other than the payment app is an app for making an order at the affiliated store, for receiving an alarm in consequence of the order, or for providing available coupon information.

10. The method of claim 1, further comprising:
receiving, from a mobile terminal, recognition information that includes the wireless LAN fingerprint collected by the mobile terminal using recognition of a Bluetooth tag or beacon installed at an affiliated store and an identifier of the Bluetooth tag or beacon or the affiliated store identifier; and
generating the fingerprint-affiliated store association database using the recognition information.

11. The method of claim 2, wherein the second step comprises:
filtering, among the wireless LAN fingerprints in the received fingerprint collection information, the wireless LAN fingerprints for a specified time before and after a time of the card payment and performing clustering with mutual similarity between the filtered fingerprints.

12. The method of claim 2, further comprising:
configuring, at a third step, at least one wireless LAN fingerprint sequence and assigning the wireless LAN fingerprints to a path between two or more affiliated stores recognized using the configured wireless LAN fingerprint sequence.

13. The method of claim 12, wherein the third step comprises:
configuring, as the wireless LAN fingerprint sequence in a series of wireless LAN fingerprints, the wireless LAN fingerprints between two wireless LAN fingerprints that have similarity, equal to or larger than a threshold value, to a stored wireless LAN fingerprint corresponding to the affiliated store.

14. An affiliated store labeling device for a wireless LAN fingerprint,
wherein the wireless LAN fingerprint is labeled as an affiliated store identifier to generate a fingerprint-affiliated store association database.

15. The device of claim 14, further comprising:
a communication unit receiving payment transaction information that is generated as card payment is performed via a card payment terminal at an affiliated store and fingerprint collection information that a mobile terminal generates by detecting a nearby wireless LAN signal; and
a control unit assigning the affiliated store identifier included in the payment transaction information to the wireless LAN fingerprint included in the fingerprint collection information by using common information that is included in both the payment transaction information and the fingerprint collection information as a link.

16. The device of claim 15, wherein the common information includes a payment transaction identifier that specifies the card payment to be performed.

17. The device of claim 15, wherein the common information includes visual information and a user identifier or an identifier of the mobile terminal.

18. The device of claim 14, further comprising:
a communication unit receiving association information that includes both the affiliated store identifier obtained in a process of performing card payment by a mobile terminal via an affiliated store terminal and the wireless LAN fingerprint collected by the mobile terminal in an associated manner; and
a control unit generating the fingerprint-affiliated store association database using the received association information.

19. The device of claim 18, wherein the association information is generated by a payment app that is installed on the mobile terminal to perform the card payment.

20. The device of claim 15, wherein the fingerprint collection information includes an identifier of a wireless AP collected by the mobile terminal and signal strength measured for a wireless signal from the wireless AP in at least one pair.

21. The device of claim 15, wherein the fingerprint collection information is generated by an app other than a payment app that is installed on the mobile terminal to perform the card payment.

22. The device of claim 14, further comprising:
a communication unit receiving, from a mobile terminal, recognition information that includes the wireless LAN fingerprint collected by the mobile terminal using recognition of a Bluetooth tag or beacon installed at an affiliated store and an identifier of the Bluetooth tag or beacon or the affiliated store identifier; and
a control unit generating the fingerprint-affiliated store association database using the recognition information.

23. A recording medium storing an app installed on a mobile terminal,
wherein the app is configured to perform at least:
generating, at a first step, association information that includes both an affiliated store identifier obtained in a process of performing card payment by the mobile terminal via an affiliated store terminal and a wireless LAN fingerprint collected by the mobile terminal in an associated manner; and
transmitting, at a second step, the association information to a computer server, and
the association information is used to generate a fingerprint-affiliated store association database in which the computer server labels the wireless LAN fingerprint as the affiliated store identifier.

24. The recording medium of claim 23, wherein the app is a payment app installed on the mobile terminal to perform the card payment.

25. The method of claim 5, wherein the fingerprint collection information includes an identifier of a wireless AP collected by the mobile terminal and signal strength measured for a wireless signal from the wireless AP in at least one pair.

26. The device of claim 18, wherein the fingerprint collection information includes an identifier of a wireless AP collected by the mobile terminal and signal strength measured for a wireless signal from the wireless AP in at least one pair.
